(19) United States
(12) Patent Application Publication
(10) Pub. No.: US 2009/0216840 A1
(43) Pub. Date: Aug. 27, 2009

(54) METHOD FOR PROVIDING SERVICES TO USER INTERFACES

(75) Inventors: Lasse Pajunen, Espoo (FI); Yaojin Yang, Espoo (FI); Zoltan Ivanfi, HU-Godollo (HU); Tamas Eppel, HU-Papa (HU); Gerard Creus Bosch, Helsinki (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 12/035,265

(22) Filed: Feb. 21, 2008

(51) Int. Cl. G06F 3/00; G06F 15/16

(52) U.S. Cl. 709/206

(57) ABSTRACT

A method for providing access to a platform independent service involving transmitting a message to a communications device the method including identifying a device category based on at least one parameter from a first group having information extractable from the communications device; mapping the device category to a user interface process, in which the user interface process describes which user interface that currently is associated with the communications device; and transforming the message format of the message from a first message format to a second message format, the second message format being associated with the user interface process, thereby providing access to the platform independent service.

### FIELD

The disclosed embodiments generally relate to providing access to a platform independent service and more particularly to a method for transforming the message from one format to a message format associated with a user interface process, and a server, a communications device, a system and a computer program product for performing the method.

### BACKGROUND

When services are being accessed e.g. ordering a pizza on the internet or paying a parking fee with your cellular phone, the service may only be accessed in one specific way and thus limits the number of devices that can be used to access the service. Some devices provide optimized user interfaces so the information is displayed in a reasonable manner, but they do not provide access methods. These optimizations are restricted to the layout of the user interface and thus their use is limited to devices that have similar capabilities apart from the size of their screens and their input methods. Some other existing solutions can be accessed in multiple ways, but these have to be implemented separately. This increases the effort, time and cost of the development. A web service uses protocols that makes it accessible through a wide range of devices, but it only provides a code interface that can be used by programs, not users. The user interface and the way of accessing the service must be implemented by the application running on the device. An additional problem here is that different user interfaces have different capabilities. For example, desktop computers have a mouse and a mobile phone a keypad or other input means. Therefore, the user interface must adapt according to the type of device being used. Consequently, there is a need for improving the way web services or other services are accessed, so the web services become available to users no matter what user interface is available to them.

### SUMMARY

In view of the above, it would be advantageous to solve or at least reduce the problems discussed above.

According to a first aspect of the disclosed embodiments there is provided a method for providing access to a platform independent service involving transmitting a message to a communications device, in which the method comprises

identifying a device category based on at least one parameter from a first group comprising information extractable from the communications device,

mapping the device category to a user interface process, in which the user interface process describes which user interface that currently is associated with the communications device, and

transforming the message format of the message from a first message format to a second message format, the second message format being associated with the user interface process, thereby providing access to the platform independent service.

Access is provided to a service that may be placed on a remote server, in another communications device, or in the communications device itself. Platform independent means that the service may be accessed through a plurality of different platforms, such as a desktop computer, a tablet pc, a cellular phone, a PDA (Personal Digital Assistant), a laptop or any other communications device. This also means that the message may be transmitted via SMS (Short Messaging Service), MMS (Multimedia Message Service), HTML (Hyper Text Markup Language) and received in a different format than the format originally transmitted. Different types of services include user services such as ordering of a pizza, payment of a parking fee, enquiries to public offices etc. and services provided for computer programs such as a web service which may be defined as a software system designed to support interoperable Machine to Machine interaction over a network. Thus a user interface process may be associated with a particular application, which is currently running on the device and which application may pertain to a service. For example if a first communications device is capable of receiving and sending messages via SMS but not via e-mail, a second communications device capable of sending e-mails may compose an e-mail message, using a first user interface pertaining to an e-mail application, That is, the current user interface of the first communications device is associated with an e-mail application. The composed e-mail message may then be sent to the first communications device. The message format is then, e.g. in a server, transformed from that of an e-mail to that of an SMS, before the converted message is delivered to the first communications device as an SMS message. Thus the recipient of the SMS message may then open the received SMS message using a second user interface pertaining to an SMS application. The web service may comprise clients and servers that communicate using XML (Extensible Markup Language) messages that follow the SOAP (Simple Object Access Protocol) standard. A message may comprise different kinds of data that may be transmitted such as text, sound, images, two-dimensional code, files or any combination thereof. Identifying a device category may be performed in a number of different ways involving different parameters. This includes extraction of data from the IMEI (International Mobile station Equipment Identity) or IMEISV (International Mobile station Equipment Identity and Software Version number) which may include information on the origin, model and serial number of the device, extraction of data from SID (Security Identifier) which is used in connection with access to resources and privileges, GPS (Global Positioning System) information to determine which motion state and or location the receiver of the message has, the phone settings to see whether the user of the mobile phone prefers to receive an SMS even though the communications device is able to receive HTML pages and the user behavior or any combination thereof. Other information that may be used in identifying a device category includes CC/PP (composite capabilities preference profiles). The CC/PP may comprise information regarding screen properties, audio properties, networking capabilities such as GPRS (General Packet Radio Service), Bluetooth, WLAN (Wireless Local Area Network) or other networking capabilities, software in the device, information concerning sensors, location information, networks available, bandwidth available (degree of media congestion), memory available, processing power available, battery life available etc. Based on at least one parameter, a device category may be identified. This information may be stored in a database. The database may contain information such as a device ID (Identification), a status, if the device is logged on to, or logged off from a network and/or service, connectivity options, information regarding a preferred network connection, group membership, for instance team leader, assistant, friend, family etc. and the message itself in one or several formats. By looking up in the database or directly extracting the information from the device, the device category can be mapped to a user interface process. This means that depending on which device category has been identified; the device category is mapped to a user interface process. The user interface process relates the user interface associated with a communications device with a particular application. The association between the user interface and the communications device may be stored in a database where a lookup may be performed. Hence a user interface process is selected and the message for example an SMS or an MMS is transformed into a generic format, that may be handled by a web service technology such as SOAP, and back to a specific format. This makes it possible to transmit messages of different kinds of formats without considering which format the receiver is able to, or prefers to, receive, as the transformation is done automatically from the users' point of view. Associations between user interfaces and the communications device may be provided automatically, based on the implementation. Alternatively the user may actively select the preferred user interface. For example the SMS message format may be selected if a high-speed network connection is not available or if the user prefers SMS. That is, a user may select different user interfaces for e.g. receiving messages. The fact that it is the user interface that is currently associated with the communications device makes it possible to always send a message in the correct and/or preferred format depending on different parameters including CC/PP. That is, at one time the correct way to send a message is by HTML, while at another time the correct way to send the message is as an SMS message. The system will assure that this is adhered to. Furthermore, the different access methods to a service are made programmatically which means that all access methods automatically become available for any service built on top of an implementation of the invention. Hence if a user wants to access a service the user may user a browser interface or an SMS interface or another desired interface.

The method may further comprise transmitting the transformed message to a user interface controller of the communications device. Hence the message is displayed in the most suitable way according to the parameters of the device category. It will take user input from a user interface and invoke certain operations on a data model and manage the view generation—i.e. what is being displayed to the user. The method may further comprise associating the message with a user interface. Hence the message is adapted according to the characteristics of the user interface thus making it possible to disseminate the message in the most user-friendly way.

The method may further comprise the first group comprising at least one property from the group of composite capabilities preference profiles (CC/PP), user profiles and meta data of the communications device. This makes it possible to adapt the message according to parameters that are very relevant to the user of the communications device. Several of the CC/PP may not be stored in a database, but require essentially immediate feedback from the receiving communications device e.g. if the WLAN is not available and the message may only be received over the GSM (Global System for Mobile communications) network. This information may be relayed to the sender or the server and can be taken into consideration when transmitting the message, thus making sure that the information will be received and that the user receives the message in his/hers preferred way.

The method may further comprise identifying the device category based on the device category of the receiver of the platform independent service. Hence the device category relates to the receiving device, which is useful since the message has to be adapted to the device category of the receiving unit.

The method may further comprise the communications device being one from a group of a mobile communications device, a PDA, a PDT (Portable Data Terminal), an Internet device, a media player, a tablet computer and a computer. Hence the invention pertains to a large number of different types of communications devices, which makes the invention very useful.

The method may further comprise the transformation process involving transforming the message from a first specific format to a generic format, and from the generic format to a second specific format. Hence this allows for easy and seamless distribution to, for example, several receivers within different device categories.

The method may further comprise the mapping being performed in a database. By storing information regarding the different device categories, it is thus possible to map the user interface process to the device category without first having to retrieve information from the receiver. This may be useful for a group of people often communicating together. For example colleagues, people in sports clubs or other organizations where the user has been registered. This may be useful if the information for some reason is difficult to retrieve or if the information is not changing.

The method may further comprise updating the database in essentially real-time. This ensures that all information is up to date and thus no messages are sent in the wrong format or over a wrong network, which may mean that the user wouldn't receive his/her message.

The method may further comprise updating the database upon identification of the device category. In this case the database is only updated when new information is received by the database, i.e. the updating procedure is event driven. The database may contain information such as a device ID, a status, if the device is logged on to, or logged off from a network and/or service, connectivity options, information regarding a preferred network connection, group membership, for instance team leader, assistant, friend, family etc. and the message itself in one or several formats.

The method may further comprise registering the user information pertaining to the communications device in a user-handling module. Here the information about the users role, such as what kind of access he or she has to information when it is being sent for example as a group message, or if the user is logged into the system or not. This provides an easy way to handle user information so the correct information is distributed to the correct users in the correct way.

According to a second aspect of the disclosed embodiments a server has been provided for accessing a platform independent service involving transmitting a message to a communications device, the server comprising circuitry configured to identify a device category based on at least one parameter from a first group comprising information extractable from the communications device, map the device category to a user interface process, in which the user interface process describes which user interface that currently is associated with the communications device, and transform the message format of the message from a first message format to a second message format, the second message format being associated with the user interface process, thereby providing access to the platform independent service. Hence such a server realizes the method for accessing a platform independent service as disclosed above.

In an embodiment the server is embedded in the sender of the transmitted message. Hence the sender may be a thick client, which means that the sender is also the one storing the information about the receivers. This means that the sender doesn't have to contact a remote server but all handling may be done inside the sender.

In another embodiment the server is embedded in the receiver of the transmitted message. This means that all or part of the handling is situated in the receiver. Thus the information used to identify the device category is always readily available. It is also possible to split up the assignments such as user handling and transformation of message, so that some actions are handled by the sender and some are handled by the receiver. The server according to the second aspect of the disclosed embodiments may comprise any features of the device according to the first aspect of the present invention.

According to a third aspect of the disclosed embodiments there has been provided a communications device comprising circuitry configured to: receive a request pertaining to a group associated with a device category, the group comprising composite capabilities preference profiles (CC/PP), user profiles and meta data of the communications device, transmit information pertaining to the group, and receive a message, wherein the message is adapted according to the transmitted information. Hence such a communications device may be used in connection with the server disclosed above.

The communications device may further comprise the adaptation of the message performed in a server. Hence it is possible for two or more thin clients to communicate together and still achieve a transformation of the message without having to reconfigure the client. So if the settings are changing for a group of clients or receivers, it is only necessary to change the settings one place, on the server, and not on every single client or receiver. This saves time.

The communications device may further comprise the server. This may be the case if the communications device is a so-called thick client. Hence in this case the transformation of the transmitted message takes place in the communications device and an external server facilitating the transformation is not needed

In another embodiment the communications device performs the adaptation of the message. This means that the information used to identify the device category is always readily available. It is also possible to split up the assignments such as user handling on transformation of message, so actions are handled by the sender and some are handled by the receiver.

The communications device may further comprise a user interface associated with the message. Hence the message is adapted according to the characteristics of the user interface thus making it possible to disseminate the message in the most user friendly way.

The communications device may further comprise circuitry configured to perform at least one from a group comprising of presenting the message, render the message, execute instructions pertaining to the message, and save the message. The communications device according to the third aspect of the disclosed embodiments may comprise any features of the device according to the first and/or second aspect of the disclosed embodiments.

According to a fourth aspect of the disclosed embodiments there has been provided a system for generating a platform independent service wherein the system comprises a server and a communications device, wherein the system, a device category is identified based on at least one parameter from a first group comprising information extractable from the communications device, the device category is mapped to a user interface process, in which the user interface process describes which user interface that currently is associated with the communications device, and the message format of the message is transformed from a first message format to a second message format, the second message format being associated with the user interface process, thereby providing access to the platform independent service. Such a system may be used in connection with the above-mentioned server and/or communications device.

The system may further comprise a server wherein the identification, the mapping and the transformation is performed. By gathering all assignments or actions in one place it is easier to change the settings in order to handle messages differently.

The system may further comprise a communications device configured to: receive a request pertaining to a group associated with the device category, transmit information pertaining to the group, and receive the message. The system according to the forth aspect of the disclosed embodiments may comprise any features of the device according to the first, second and/or third aspect.

According to a fifth aspect of the disclosed embodiments a computer program product comprising computer program code stored on a computer-readable storage medium which, when executed on a processor, carries out any of the previously discussed methods. The computer program product according to the fifth may comprise any features of the device according to the first, second third and /or fourth aspect of the disclosed embodiments.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The aspects of the disclosed embodiments will now be described in more detail, reference being made to the enclosed drawings, in which:

FIG. 1 is a schematic illustration of a cellular telecommunication system, as an example of an environment in which the aspects of the disclosed embodiments may be applied.

FIG. 2 is a schematic front view illustrating a mobile terminal according to an embodiment.

FIG. 3 is a schematic block diagram representing an internal component, software and protocol structure of the mobile terminal shown in FIG. 2.

FIG. 4 is a flow chart illustrating an embodiment.

FIG. 5 is a flow chart illustrating one embodiment.

FIG. 6 is a diagram illustrating the high level architecture of an embodiment.

FIG. 7 is a diagram illustrating a high level design of the system of group messaging process.

FIG. 8 is a diagram illustrating Implementation of the system of group messaging process.

### DETAILED DESCRIPTION OF EMBODIMENTS

The aspects of the disclosed embodiments will now be described more fully hereinafter with reference to the accompanying drawings, in which certain embodiments of the invention are shown. This invention may, however, may be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

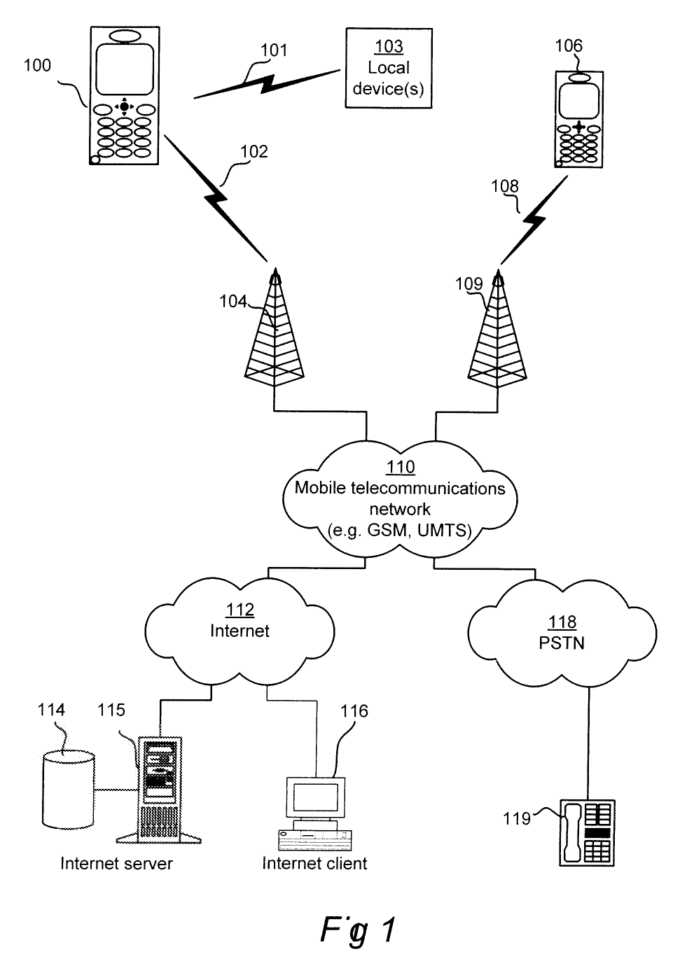

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a communications device 100 according to the present invention and other devices, such as another communications device 106 or a stationary telephone 119. It is to be noted that for different embodiments of the communications device 100 and in different situations, different ones of the telecommunications services referred to above may or may not be available; the invention is not limited to any particular set of services in this respect.

The communications devices 100, 106 are connected to a mobile telecommunications network 110 through radio frequency (RF) links 102, 108 via base stations 104, 109. The mobile telecommunications network 110 may be in compliance with any commercially available mobile telecommunications standard, such as Global System Mobile (GSM), Universal Mobile Telecommunications System (UMTS), Digital-Advanced Mobile Phone Service (D-AMPS), Code Division Multiple Access2000 (CDMA2000), (Freedom of Mobile Multimedia Access) FOMA and Time Division-Synchronous Code Division Multiple Access (TD-SCDMA). The mobile telecommunications network 110 is operatively connected to a wide area network 112, which may be Internet or a part thereof. An Internet server 115 has a data storage 114 and is connected to the wide area network 112, as is an Internet client computer 116. The server 115 may host a www/wap server capable of serving www/wap content to the communications device 100. A public switched telephone network (PSTN) 118 is connected to the mobile telecommunications network 110 in a familiar manner. Various telephone terminals, including the stationary telephone 119, are connected to the PSTN 118. The communications device 100 is also capable of communicating locally via a local link 101 to one or more local devices 103. The local link can be any type of link with a limited range, such as Bluetooth®, a Universal Serial Bus (USB) link, a Wireless Universal Serial Bus (WUSB) link, an IEEE 802.11 wireless local area network link, a recommended standard 232 (RS-232) serial link, etc.

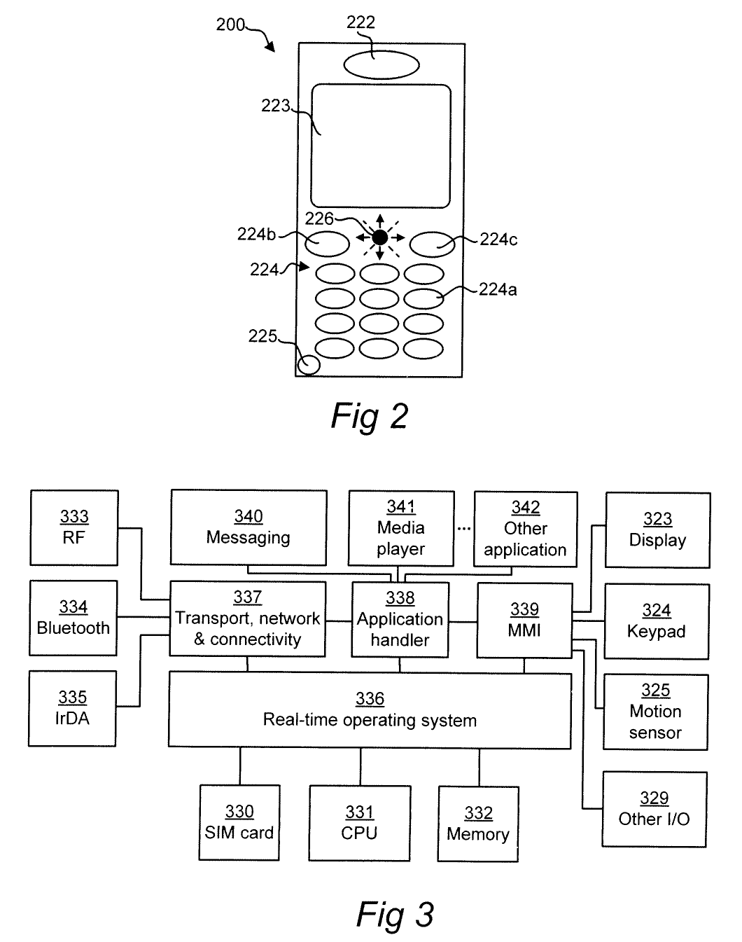

An embodiment 200 of the communications device 100 is illustrated in more detail in FIG. 2. The communications device 200 comprises a speaker or earphone 222, a microphone 225, a display 223 and a set of keys 224 which may include a keypad 224a of common International Telecommunications Union Telecommunication Standardization Sector (ITU-T) type (alpha-numerical keypad representing characters “0”-“9”, “*” and “#”) and certain other keys such as soft keys 224b, 224c and a joystick 226 or other type of navigational input device.

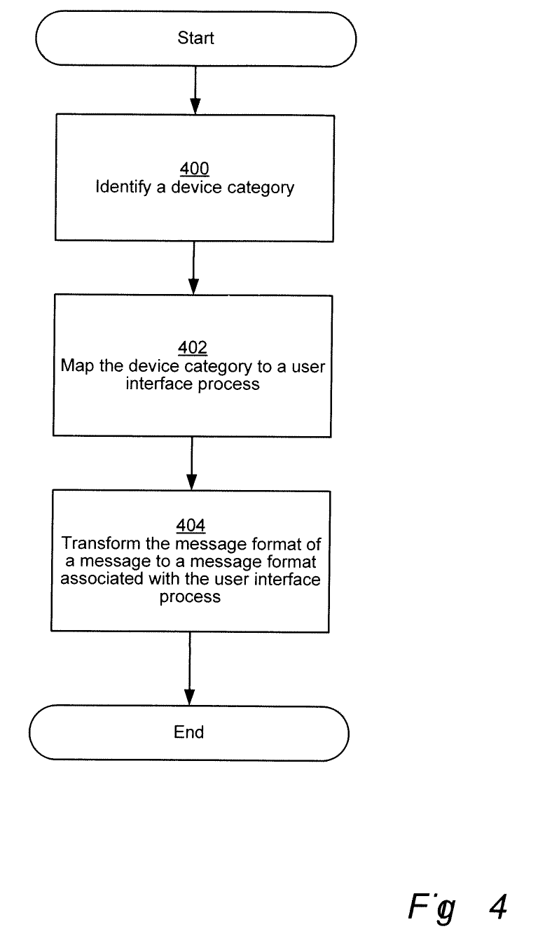

The internal component, software and protocol structure of the communications device 200 will now be described with reference to FIG. 3. The communications device has a controller 331, which is responsible for the overall operation of the communications device and is preferably implemented by any commercially available Central Processing Unit (CPU), Digital Signal Processor (DSP) or any other electronic programmable logic device. The controller 331 has associated electronic memory 332 such as random access memory (RAM), Read-only memory (ROM), Electrically Erasable Programmable Read-Only-Memory (EEPROM), flash memory, or any combination thereof. The memory 332 is used for various purposes by the controller 331, one of them being for storing data and program instructions for various software in the communications device. The software includes a real-time operating system 336, drivers for a man-machine interface (MMI) 339, an application handler 338 as well as various applications. The applications can include a messaging application 340 for sending and receiving SMS, MMS or e-mail, a media player application 341, as well as various other applications 342, such as applications for voice calling, video calling, web browsing, an instant messaging application, a phone book application, a calendar application, a control panel application, a camera application, one or more video games, a notepad application, etc. The MMI 339 also includes one or more hardware controllers, which together with the MMI drivers cooperate with the display 323/223, keypad 324/224, motion sensor 325, such as an accelerometer, as well as various other input/output (I/O) devices 329 such as microphone, speaker, vibrator, ring tone generator, light emitting diode (LED) indicator, etc. As is commonly known, the user may operate the communications device through the man-machine interface thus formed. The software also includes various modules, protocol stacks, drivers, etc., which are commonly designated as 337 and which provide communication services (such as transport, network and connectivity) for an RF interface 333, and optionally a Bluetooth® interface 334 and/or an Infrared Data Association (IrDA) interface 335 for local connectivity. The RF interface 333 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.e., band pass filters, amplifiers, mixers, local oscillators, low pass filters, analog-to-digital/digital-to-analog (AD/DA) converters, etc. The communications device also has a subscriber identity module (SIM) card 330 and an associated reader. As is commonly known, the SIM card 330 comprises a processor as well as local work and data memory.

Now follows diagrams and flow charts presenting the system according to an embodiment of the present invention.

FIG. 4 is a flow chart illustrating an embodiment. In Step 400 a device category is identified. A device category may be identified through data extracted from different data containers such as the IMEI or IMEISV, the SID, a GPS, or other data extractable from the communications device. The information on the device category comprises CC/PP properties such as screen properties, audio properties, networking capabilities such as GPRS, Bluetooth, WLAN, software in the device, information concerning censors, location information, networks available, bandwidth available (degree of media congestion), memory available, processing power available, battery life available etc. The information extracted may be stored in a database on a server and handled by a user handling module. The database may be updated essentially in real time or upon identification of the device category. By looking up in the database or directly extracting the information from the device, the device category can be mapped to a user interface process. This means that depending on which device category has been identified; the device category is mapped to a user interface process 402. In Step 404 the message format of a message is transformed to a message format associated with the user interface process. The user interface process may be selected and the message, for example an SMS or an MMS, is transformed into a generic format that may be handled by a web service technology such as SOAP, and then transformed back to a specific format. The user interface process may be responsible for generating particular views for a certain user interface.

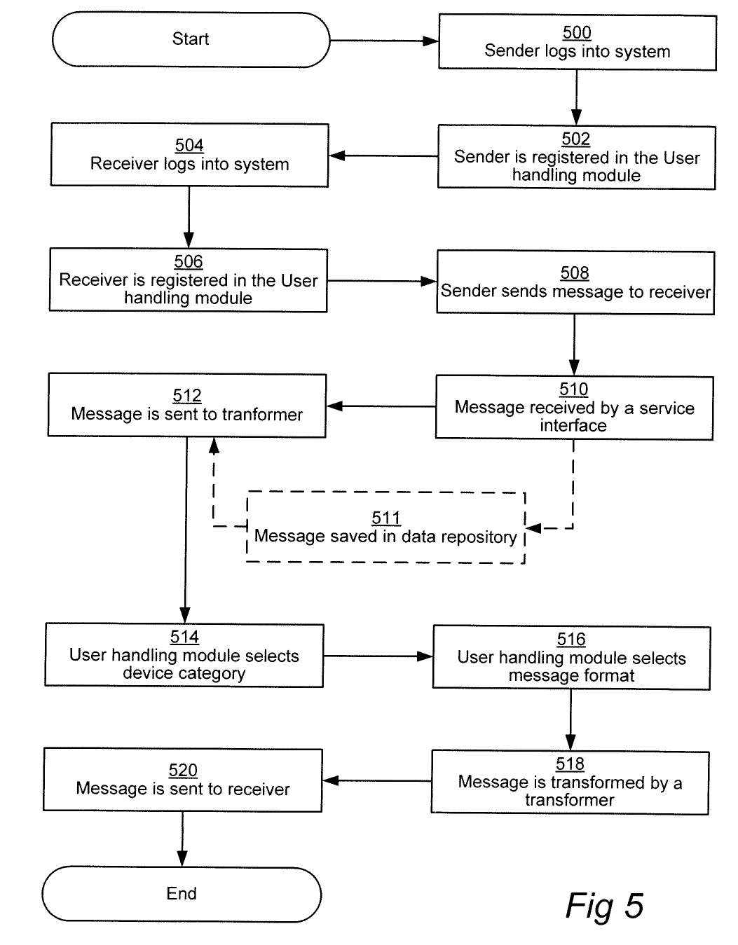

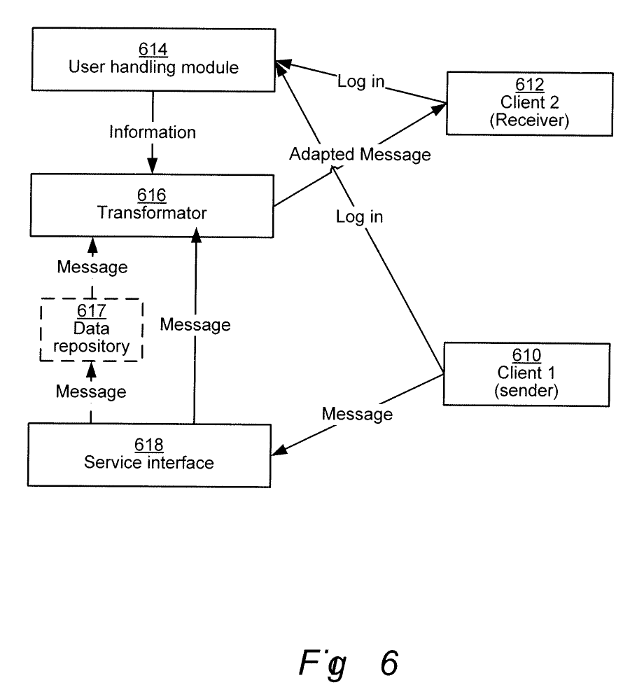

FIG. 5 is a flow chart illustrating one embodiment. Here it is shown how a message is sent from a sender to a receiver. In step 500 the sender logs into the system and is in step 502 registered in the system. The receiver logs into the system 504 and is registered 506 as well. Alternatively no logging on is required in order for the system to function. In step 508 the sender sends a message to the receiver, the receiver which may be unaware of what is happening inside the system. In step 510 the message is received by a service interface and then the message is either sent to a transformer 512 or saved in a data repository 511. The data repository might be useful if the message is to be sent to several receivers or if the sender expects an answer/confirmation on the sent message, as the message then can be resent or distributed to more receivers. In step 514 the user handling module selects a device category. This may include actions such as looking up in a database to see who the receivers are. The receiver may be members of different groups or have different roles, so for instance an SMS is sent out to “all team leaders”. Hence the individual receivers are then selected based on this group membership. In step 516 a user handling module selects message format and the receivers are able to receive the message in different formats depending on their device category. In step 518 the message is transformed by a transformer. This may be done with help from a XSLT processor. In step 520 the message is sent to a receiver or several receivers.

FIG. 6 is a schematic diagram illustrating the high level architecture of an embodiment of the proposed method. This embodiment comprises a 610 client 1 (sender), 612 client 2 (receiver), 614 a user handling module, 616 transformer, (not mandatory) 617 data repository, and a service interface 618. The process illustrated here is essentially the same process as illustrated in FIG. 5, but in FIG. 6 the communication between the different parts is illustrated, while in FIG. 5 the flow-chart of the method is illustrated.

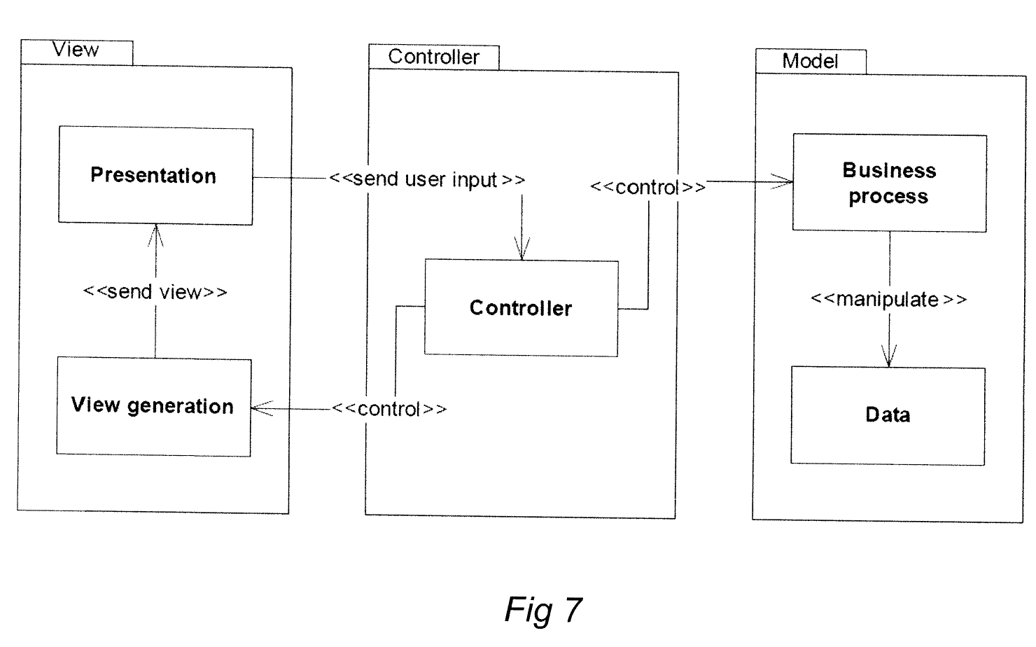

FIG. 7 is a diagram illustrating a high level design of the system of a group messaging process. This is an embodiment showing how an implementation in a Model, View, Controller pattern looks. In the View module, the class of Presentation represents a collection of related components for rendering device specific user interfaces; the class of View generation is a collection of related components for creating user interface views that are then going to be presented locally in each device. Multiple instances of View generation may be deployed onto the system. Each of them may be deployed separately as a stand alone deployment unit and will take care of one certain type of user interface. In this embodiment two different types of user interfaces, HTML-based and SMS-based, are being used. The HTML-based user interface may serve both desktop computers and high-end mobiles with pull style interaction; the SMS-based user interface may serve low-end mobiles with push style interaction. Consequently, there will be two instances of View generation deployed separately onto the system. The instances could be deployed on the client if the client's capability allows, but, in this embodiment, they will be deployed on the server in order to achieve better performance and impose centralized control on view generation. The Controller module serves as a communication hub between the View module and the Model module. It takes user inputs from user interfaces, then interpret the inputs to requests of invoking certain operations on a data model, and finally manage the view generation to produce new views of the user interface according to results from operations. In the Model module, the class of Business process represents a set of related components that implements group messaging related functions such as joining a group, handle replies from receivers etc. The class of Data encapsulates the data repository of the system and any data-related lower-level services for accessing and manipulating raw data. In a message delivery procedure, the message is first sent to and saved in the data repository, and then retrieved from the data repository and sent to recipients. The server side and device-to-server communication may be based on a standard mechanism, while the device side communication may be performed in the devices' native ways. About the standard mechanism, the SOAP may be choosen over other protocols, as the primary communication protocol, because it is a de facto standard. However, as mobile devices may lack SOAP support or considering performance issues, it might be necessary to have additional adapters to convert protocols between HTML and SOAP and between SMS and SOAP.

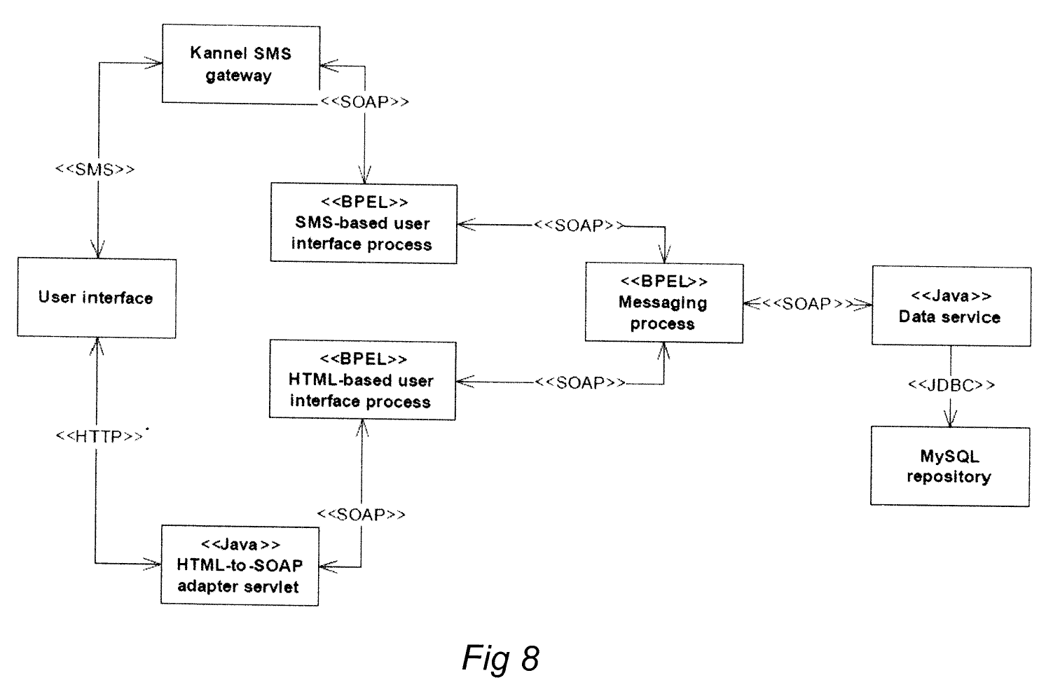

FIG. 8 is a diagram illustrating Implementation of the system of group messaging process. FIG. 8 shows the different technologies that may be used. Here the Business Process Execution Language for Web Services (BPEUBPEL4WS) has been used as the implementation language of the processes, as the system is business process-oriented and all tasks can be modelled and implemented as processes. Furthermore, the system is a long-running system, which may require compensation actions and scoping to support failure recovery and, the system may rely on a flexible deployment mechanism in order to be able to deploy components even after initial deployment. Due to the flexible deployment mechanism supported by BPEL implementations, the instances of view generation, presented in the design, are implemented as BPEL processes. In the implemented system there may be e.g. three BPEL processes, HTML-based user interface process, SMS-based user interface process, and messaging process. The first two processes may be responsible for view generation and also have a Controller role to connect the device to the messaging process. The last process is where the actual messaging related business logic is implemented. The HTML-to-SOAP adapter may be implemented as a Java Servlet, which can convert messages between HTTP and SOAP. The SMS-to-SOAP adapter may be based on the Kannel, an open source SMS gateway, which can convert messages between SMS and SOAP. Relational database, MySQL, may be used as a Data repository, which the messaging process can gain access to through the Data service.

Further aspects of user interfaces for the group messaging processes described herein can be found in the articles entitled “Developing Agile User Interfaces for Heterogeneous Devices in Business Process” by Yaojin Yang, Lasse Pajunen, Nokia Research Center, 9^{th} International Conference on Enterprise Information Systems, Funchal, Madeira, Portugal, June 2007; and “Towards Supporting User Interface Agility in Developing Heterogeneous Device Enabled Business Processes” by Yang Yaojin and Pajunen Lasse, Nokia Research Center, 2007 ACM Symposium on Applied Computing, Seoul, Korea, March 2007; the disclosure of each being incorporated herein by reference in its entirety.

Although the invention has above been described using an embodiment in a communications device, a server and a system, the invention is applicable to any type of apparatus capable sending and receiving messages, including pocket computers, portable mp3-players, portable gaming devices, cameras, lap-top computers, desktop computers etc.

The invention has mainly been described above with reference to a few embodiments. However, as is readily appreciated by a person skilled in the art, other embodiments than the ones disclosed above are equally possible within the scope of the invention, as defined by the appended patent claims.

1. A method for providing access to a platform independent service involving transmitting a message to a communications device, the method comprising:
identifying a device category based on at least one parameter from a first group comprising information extractable from the communications device;
mapping the device category to a user interface process, in which the user interface process describes which user interface that currently is associated with the communications device; and
transforming the message format of the message from a first message format to a second message format, the second message format being associated with the user interface process, thereby providing access to the platform independent service.

2. The method according to claim 1 comprising transmitting the transformed message to a user interface controller of the communications device.

3. The method according to claim 1 wherein the message is associated with a user interface.

4. The method according to claim 1 wherein the first group of information extractable from the communications device comprises at least one property from a group of composite capabilities preference profiles (CC/PP), user profiles and meta data of the communications device.

5. The method according to claim 1 wherein the device category is identified based on the device category of a receiver of the platform independent service.

6. The method according to claim 1 wherein the communications device is one from a group of a mobile communications device, a personal digital assistant (PDA), a portable data terminal (PDT), an Internet device, a media player, a tablet computer and a computer.

7. The method according to claim 1 wherein the transformation process involves transforming the message from a first specific format to a generic format, and from the generic format to the second specific format.

8. The method according to claim 1 wherein the mapping is performed in a database.

9. The method according to claim 8 wherein the database is updated essentially in real-time.

10. The method according to claim 8 wherein the database is updated upon said identification of device category.

11. The method according to claim 1 wherein user information pertaining to the communications device is registered in a user-handling module.

12. A server for providing access to a platform independent service involving transmitting a message to a communications device, the server comprising circuitry configured to:
identify a device category based on at least one parameter from a first group comprising information extractable from the communications device;
map the device category to a user interface process, in which the user interface process describes which user interface that currently is associated with the communications device; and
transform the message format of the message from a first message format to a second message format, the second message format being associated with the user interface process, thereby providing access to the platform independent service.

13. The server according to claim 12 wherein the server is embedded in the sender of the transmitted message.

14. The server according to claim 12 wherein the server is embedded in the receiver of the transmitted message.

15. A communications device comprising circuitry configured to:
receive a request pertaining to a group associated with a device category, the group comprising composite capabilities preference profiles (CC/PP), user profiles and meta data of the communications device,
transmit information pertaining to the group, and
receive a message, wherein the message is adapted according to the transmitted information.

16. The communications device according to claim 15 wherein the adaptation of the message is performed in a server.

17. The communications device according to claim 16 wherein the communications device comprises the server.

18. The communications device according to claim 15 wherein the adaptation of the message is performed in the communications device.

19. The communications device according to claim 15 wherein the message is associated with a user interface.

20. The communications device according to claim 15 further comprising circuitry configured to perform at least one from a group comprising of presenting the message, render the message, execute instructions pertaining to the message, and save the message.

21. A system for generating a platform independent service wherein the system comprises a server and a communications device, wherein in the system
a device category is identified based on at least one parameter from a first group comprising information extractable from the communications device,
the device category is mapped to a user interface process, in which the user interface process describes which user interface that currently is associated with the communications device, and
the message format of the message is transformed from a first message format to a second message format, the second message format being associated with the user interface process, thereby providing access to the platform independent service.

22. The system according to claim 21 wherein
the identification, the mapping and the transformation are performed in the server.

23. The system according to claim 22 wherein the communications device is configured to:
receive a request pertaining to a group associated with the device category,
transmit information pertaining to the group, and
receive the message.

24. A computer program product comprising computer program code stored on a computer-readable storage medium which, when executed on a processor, carries out the method according to claim 1.
